(19) United States
(12) Patent Application Publication
(10) Pub. No.: US 2023/0415670 A1
(43) Pub. Date: Dec. 28, 2023

(54) COVER ELEMENT HAVING A DISPLAY AREA DESIGNED TO EXTEND IN FRONT OF A DISPLAY ELEMENT, ASSOCIATED DISPLAY ASSEMBLY, METHOD FOR MANUFACTURING AND TRIM ELEMENT

(71) Applicant: Faurecia Clarion Electronics Europe, Paris (FR)

(72) Inventors: Edouard DA SILVA, Herblay (FR); Lin Cong, Rochester, MI (US)

(21) Appl. No.: 18/336,856

(22) Filed: Jun. 16, 2023

(30) Foreign Application Priority Data
Jun. 23, 2022 (FR) FR 22 06243

(51) Int. Cl. B60R 13/02; B60R 11/02

(52) U.S. Cl. CPC B60R 13/02; B60R 11/0229; B60R 2013/0287

(57) ABSTRACT

A cover element having a display area extending in front of a display element and forming an external surface of the element, the display area being configured to present a visual appearance of a predefined material and having a texture of the predefined material. The element includes: a support having a part being translucent and having external and internal faces, a portion of the external face forming the display area, the portion having the texture of the predefined material and the support having a material distinct from the predefined material, and a decorative layer extending on the internal face of the part of the support, a portion of the decorative layer having the visual appearance of the predefined material, the portion of the decorative layer extending in front of the display area.

### TECHNICAL FIELD

The invention concerns a cover element. The invention also concerns a display assembly comprising the cover element. The invention also concerns a method for manufacturing the cover element. The invention also concerns a trim element comprising the display assembly.

The cover element according to the invention is for example a cover element designed to be arranged in a vehicle.

### BACKGROUND

Known cover elements have a display area designed to extend in front of a display element configured to generate an image.

Such known cover elements comprise an aesthetic layer made of a genuine material such as wood, leather or metal.

This aesthetic layer is configured to hide the display element when it does not generate any image. However, such cover elements made of such aesthetic layers are generally very expensive due to the use of the aesthetic layer made of the genuine material.

### SUMMARY

One aim of the invention is to overcome the above-mentioned drawbacks by proposing a cover element being less expensive and presenting a favorable aspect.

For this purpose, the invention relates to a cover element having a display area designed to extend in front of a display element configured to generate a displayed content, the display area forming at least a part of an external surface of the cover element, the display area being configured to present a visual appearance of a predefined material and the display area having a texture of the predefined material, the cover element comprising:
a support comprising at least a part being translucent, said translucent part of the support having an external face and an internal face opposed to the external face, at least a portion of the external face of the translucent part of the support forming the display area, said portion of the external face of the translucent part of the support having the texture of the predefined material, the support comprising a material distinct from said predefined material, and
a decorative layer extending at least on the internal face of the translucent part of the support, at least a portion of the decorative layer having the visual appearance of the predefined material, said portion of the decorative layer extending at least in front of the display area.

Thanks to said portion of the decorative layer having the visual appearance of the predefined material, the display area is able to present the visual appearance of the predefined material. In particular, for example, the display area presents the visual appearance of the predefined material when the display zone extends in front of a display element which is switch off.

Thanks to said portion of the external face of the support, the display area presents the texture of the predefined material. Thus, by touching the display area a person can feel the texture of the predefined material.

Thus, the combination of the portion of the decorative layer and the portion of the support enables to reproduce the visual appearance and the feeling of touching of a predefined material, being for example a genuine material such as leather, wood, metal, etc.

Additionally, it is possible to choose inexpensive materials as compared to genuine materials to realize the cover element and in particular to imitate the visual appearance and the texture of the predefined material, i.e. to obtain a favorable aspect of the cover element.

Thus, the cover element according to the invention may be less expensive than known trim elements and has a pleasant visual appearance and touch feeling.

The cover element may comprise one or more of the following features, taken into consideration in isolation or according to any technically admissible combinations:
said portion of the decorative layer comprises a decorative pattern having the visual appearance of the predefined material.
said portion of the decorative layer is translucent and advantageously presents a light transmission rate superior or equal to 30% and inferior or equal to 40%.
at least said portion of the decorative layer presents a transmission haze rate superior or equal to 10% and inferior or equal to 50%.
said portion of the decorative layer has a thickness superior or equal to 180 micrometers and inferior or equal to 500 micrometers.
at least the translucent part of the support comprises a substrate layer, at least an etched part of the substrate layer defining at least in part said portion of the external face of the translucent part of the support and/or at least the translucent part of the support comprising at least a coating layer extending on the substrate layer and delimiting at least in part said portion of the external face of the translucent part of the support.
at least the translucent part of the support comprises at least a coating layer extending on the substrate layer, the coating layer delimiting at least in part said portion of the external face of the translucent part of the support, the coating layer comprising an antiglare material, the antiglare material having preferably the following chemical formula: TiZrO₂.
at least the translucent part of the support comprises at least a coating layer extending on the substrate layer, the coating layer delimiting at least in part said portion of the external face of the translucent part of the support, the coating layer comprising an antireflection material, the antireflection material being preferably silicon dioxide.
at least the translucent part of the support comprises a substrate layer, the translucent part of the support further comprising a first coating layer and a second coating layer extending on the substrate layer, the first coating layer being arranged between the substrate layer and the second coating layer, the second coating layer delimiting at least in part said portion of the external face of the translucent part of the support having the texture of the predefined material, one of the coating layers among the first and the second coating layers comprising an antiglare material and the other of the coating layers among the first and the second coating layers comprising an antireflection material, the antiglare material having preferably the chemical formula TiZrO₂ and the antireflection material being preferably silicon dioxide.

The invention also concerns a display assembly comprising a cover element as described above, a display element configured to generate a displayed content, the display area of the cover element extending in front of the display element, said display assembly being configured to display in the display area the visual appearance of the predefined material when said display element is turned off and said display assembly being configured to display in the display area the displayed content when said display element is turned on, said displayed content being different from the visual appearance of the predefined material.

The invention also concerns a method for manufacturing a cover element having a display area designed to extend in front of a display element configured to generate a displayed content, the display area forming at least a part of an external surface of the cover element, the display area being configured to present the visual appearance of a predefined material and the display area having the texture of the predefined material, the method comprising the following steps:
realizing a support comprising at least a part being translucent, said translucent part of the support having an external face and an internal face opposed to the external face, at least a portion of the external face of the translucent part of the support forming the display area, said portion of the external face of the translucent part of the support having the texture of the predefined material, the support comprising a material distinct from said predefined material,
the step of realizing the support comprising a sub-step of etching at least a part of a substrate layer of the translucent part of the support and/or a sub-step of coating at least a coating layer on a substrate layer of the translucent part of the support to form said portion of the external face of the translucent part of the support having the texture of the predefined material,
providing a decorative layer having at least a portion having the visual appearance of the predefined material, and
assembling the provided decorative layer to the internal face of the translucent part of the realized support, said portion of the decorative layer having the visual appearance of the predefined material extending at least in front of the display area.

According to a particular embodiment, the step of realizing the support depends on the values of pixels of an acquired image of the predefined material or on the values of the pixels of a filtered acquired image of the predefined material.

The invention also concerns a method for manufacturing a cover element having a display area designed to extend in front of a display element configured to generate a displayed content, the display area forming at least a part of an external surface of the cover element, the display area being configured to present a visual appearance of a predefined material and the display area having the texture of the predefined material, the method comprising the following steps:
realizing a support comprising at least a part being translucent, said translucent part of the support having an external face and an internal face opposed to the external face, at least a portion of the external face of the translucent part of the support forming the display area, said portion of the external face of the translucent part of the support having the texture of the predefined material, the support comprising a material distinct from said predefined material,
the step of realizing the support comprising a sub-step of etching at least a part of a substrate layer of the translucent part of the support and/or a sub-step of coating at least a coating layer on a substrate layer of the translucent part of the support to form said portion of the external face of the translucent part of the support having the texture of the predefined material,
coating a decorative layer on the internal face of the translucent part of the realized support to have at least a portion having the visual appearance of said predefined material, said portion of the coated decorative layer extending at least in front of the display area.

The method for manufacturing may comprise one or more of the following features, taken into consideration in isolation or according to any technically admissible combinations:
the step of realizing the support depends on the values of pixels of an acquired image of the predefined material or on the values of the pixels of a filtered acquired image of the predefined material.
the step of coating the decorative layer comprises printing or spraying a decorative coating of the decorative layer on the internal face of the translucent part of the support to form said portion of the decorative layer having the visual appearance of the decorative layer.

The invention also concerns a trim element for a vehicle comprising a display assembly as described above, the trim element comprising advantageously an appearance layer having an external face, at least a part of the external face of the appearance layer extending at least partially around the display area of the cover element of the display assembly, said part of the external face of the appearance layer having a visual appearance similar to the visual appearance of the portion of the decorative layer of the cover element having the visual appearance of the predefined material.

### BRIEF DESCRIPTION OF THE DRAWINGS

The invention and its advantages will be better understood upon reading the following description, which is given solely by way of non-limiting example and which is made with reference to the appended drawings, in which:

FIG. 1 is a cross sectional view of a display assembly comprising a cover element according to an embodiment of the invention,

FIG. 2 is a schematic representation of a predefined material,

FIG. 3 is a front view of a decorative layer of the cover element of FIG. 1,

FIG. 4 is a detailed view of zone IV of the display assembly of FIG. 1,

FIG. 5 is a front view of the display assembly of FIG. 1 in a resting configuration of a display element of the display assembly,

FIG. 6 is a front view of the display assembly of FIG. 1 in an illumination configuration of a display element of the display assembly,

FIG. 7 is a cross sectional view of a trim element comprising the display assembly of FIG. 1.

### DETAILED DESCRIPTION

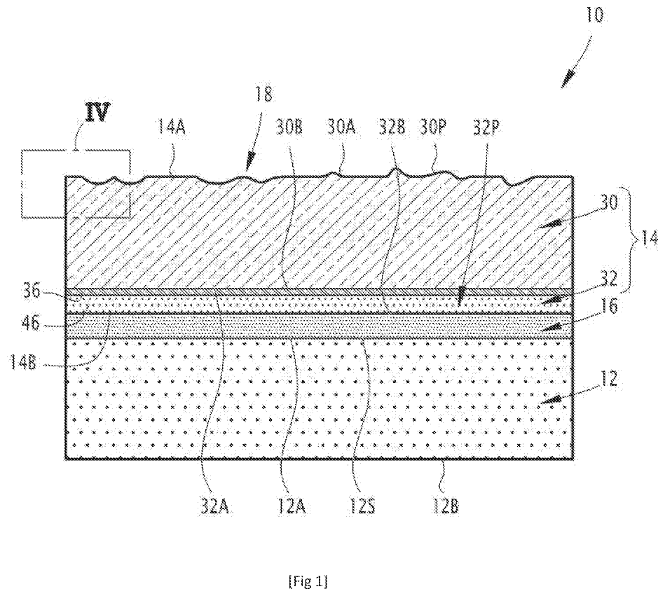

In reference to FIGS. 1 to 6, a display assembly 10 according to an embodiment of the invention is described.

The display assembly 10 is for example a display assembly of a vehicle.

In the following description, the term “internal” or “interior” refers to an element designed to be oriented towards the inside of the display assembly 10 and namely towards a side of a carrier on which the display assembly 10 is fixed. The term “external” or “exterior” refers to an element designed to be oriented towards the exterior of the display assembly 10, namely towards the part of the vehicle's interior on which the display assembly 10 is installed.

The display assembly 10 comprises a display element 12 and a cover element 14. As shown on FIG. 1, the cover element 14 extends in front of the display element 12. The cover element 14 can also be called “cover lens”. In the example shown on FIG. 1, the display assembly 10 further comprises an optical bonding layer 16 extending between the cover element 14 and the display element 12.

In the present description, by “a first element is or extends in front of a second element” it is understood that the first element and the second element are superposed to each other along the direction separating an external surface and an internal surface of the cover element 14.

The display element 12 has an external face 12A and internal face 12B.

The external face 12A of the display element 12 extends in front of the cover element 14.

The external face 12A of the display element 12 defines at least in part a display surface 12S of the display element 12.

The display surface 12S extends in front of an external surface 14A of the cover element 14.

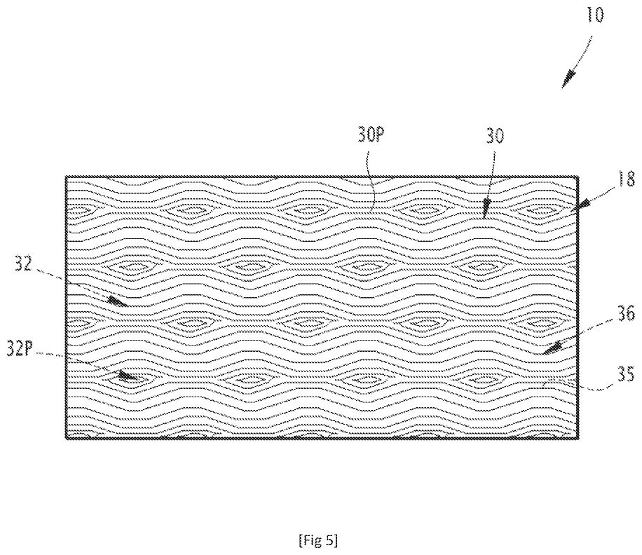

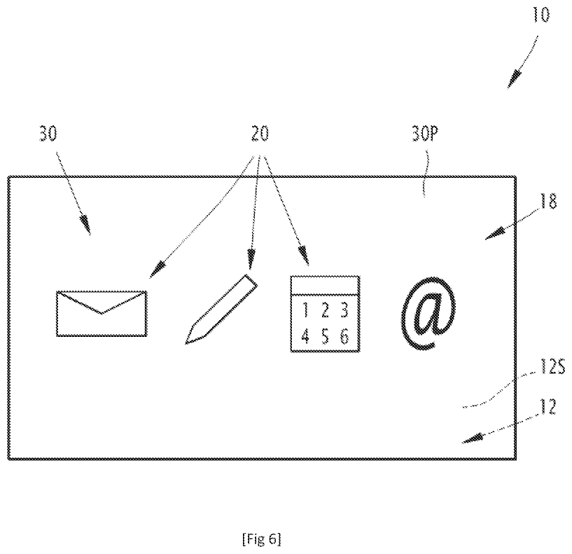

The display assembly 10 is configured to display in a display area 18 of the cover element 14 a visual appearance of a predefined material, described in more details below, when said display element 12 is turned off (FIG. 5) and the display assembly 10 is configured to display in the display area 18 a displayed content 20 different from the visual appearance of the predefined material when said display element 12 is turned on (FIG. 6).

In particular, the display element 12 is configured to present an illumination configuration (FIG. 6) wherein the display element 12 illuminates a display area 18 (i.e. is turned on) of the cover element 14 and generates the displayed content 20 such as an image also referenced by “20” and a resting configuration (FIG. 5) wherein the display element 12 does not illuminate said display area 18 (i.e. is turned off).

In particular, in the illumination configuration (FIG. 6), the display element 12 emits light beams towards the display area 18. The light beams have for example a wavelength belonging to the visible range. Additionally, in the illumination configuration, the image 20 is displayed by the display surface 12S of the display element 12.

In the resting configuration (FIG. 5), the display element 12 does not emit any light beams and is for example off. For example, in the resting configuration, the display surface 12S is black and does not emit any light beam.

For example, the display element 12 is a screen.

The screen is, for example, formed by a matrix of pixels.

The screen is, for example, a light-emitting screen, in particular a light-emitting diode (LED) screen, in particular an organic light emitting diode (OLED) screen.

Alternatively, the screen is a liquid crystal display (LCD).

The screen is advantageously an active matrix screen. Such a screen has an active matrix comprising one or more transistors dedicated to each pixel of the screen and allowing to control each pixel individually. The active matrix is for example of the TFT type (for “thin film transistor”). The active matrix display can be an AMOLED screen (for “active matrix organic light-emitting diode”) or an AMLCD screen (for “active matrix liquid crystal display”).

In reference to FIG. 1, the cover element 14 comprises said external surface 14A and an internal surface 14B opposed to said external surface 14A. As mentioned above, the cover element 14 has a display area 18 arranged in front of the display element 12.

The display area 18 forms at least a part of said external surface 14A of the cover element 14.

The display area 18 extends at least in front of the display surface 12S of the display element 12. For example, the display area 18 extends in front of the whole external face 12A of the display element 12.

The display area 18 is a visible area so that the display area 18 is visible from the interior of the vehicle. Additionally, the display area 18 is configured to be touched by a person of the interior of the vehicle.

The display area 18 is configured to present the visual appearance of a predefined material 22 (see FIG. 5) and the display area 18 has the texture of the predefined material 22 (see FIG. 1).

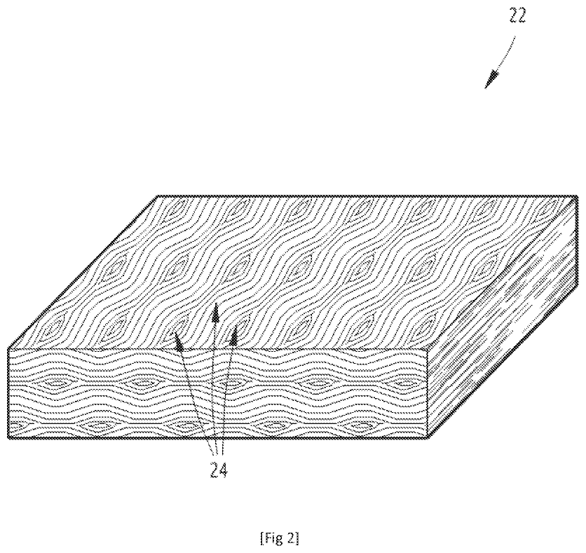

One example of predefined material 22 is shown on FIG. 2.

In the specific example of FIG. 2, the predefined material 22 is wood and represented on this FIG. 2 by a piece of wood having a surface. For example the wood can be at least one kind of wood chosen in the following list: segal teak, curved wood, brown mazur birch, gray mazur birch, carbon wood, makassar wood, etc. All those kinds of wood have different visually appearances and textures.

As a variant the predefined material 22 can be for example leather, metal, a knitted fabric, a woven fabric, a non-woven fabric, a velvet material, etc.

The visual appearance of the predefined material 22 corresponds to the visual perception of the predefined material 22 when a person looks at the predefined material 22 with the naked eye.

In particular, the visual appearance of the predefined material 22 comprises a characteristic pattern of the predefined material 22, for example a characteristic pattern of a surface of the predefined material 22, and/or a particular visual surface aspect such as a glossy or shining aspect which is characteristic of the predefined material 22.

In the case of the piece of wood of FIG. 2, the visual appearance of the wood of this piece of wood is defined at least in part by a pattern 24 of a surface of the piece of wood. For example, the pattern 24 of the surface of the piece of wood comprises the lines and knots of wood.

By “the display area 18 is configured to present the visual appearance of the predefined material 22” it is understood that the display area 18 is configured to display at least some elements of the visual appearance of the predefined material 22, for example at least some portions of the pattern 24 of the surface of the predefined material 22. For example, those portions of the pattern 24 are chosen so that the nature of the predefined material 22 can be identified when seeing those portions with the naked eye.

In particular, and as described in the following, the display area 18 presents the visual appearance of the predefined material 22 when the display element 12 is in the resting configuration. In other words, the display assembly 10 is configured to display in the display area 18 the visual appearance of the predefined material 22. For example, in the case of the predefined material 22 of FIG. 2, the visual appearance displayed in the display area 18 comprises at least some elements of the pattern 24 of the piece of wood, namely at least some lines and/or some knots of the wood, so that when a person looks at the display area 18, he/she can recognized the visual aspect of wood.

The texture of the predefined material 22 provides to a person a touch feeling, for example when he/she touches the predefined material 22 with his hands, which is characteristic of the predefined material 22. In particular, the texture of the predefined material 22 enables to recognize the predefined material 22 by touching said texture.

The texture of the predefined material 22 is, for example, defined by the roughness of a surface of the predefined material 22.

As a complement or in variant, the texture of the predefined material 22 is for example defined by the macroscopic shape of the surface of the predefined material 22.

In the present description, by “macroscopic shape” it is understood the macroscopic surface condition of the surface of the predefined material 22.

Touch feeling can correspond to a rough touch feeling, a silky touch feeling, a soft touch feeling, the feeling of touching a corrugated surface, the feeling of touching a smooth surface, etc.

In the case of the predefined material 22 of FIG. 2, the touch feeling of wood corresponds for example to a rough touch feeling generated by the irregular surface of the wood, and, in particular, generated by the lines and the knots of wood.

By “the display area 18 has the texture of the predefined material 22” it is understood that the texture of the display area 18 comprises at least some parts of the texture of the predefined material 22. In other words, the display area 18 comprises at least some parts of the texture of the predefined material 22 so that when a person touches the display area 18 he/she can feel the texture of the predefined material 22 and recognize the predefined material 22. For example, those parts of the texture are chosen so that the nature of the predefined material 22 can be identified when touching those parts. The texture of the display area 18 corresponds for example to a surface having a tridimensional texture.

In the case of the predefined material 22 of FIG. 2, the texture of the display area 18 corresponds for example to the most prominent parts of the texture of the wood of the piece of wood conferring to the piece of wood its woody aspects so that when touching the display area 18, a person can have a touch feeling of a piece of wood.

As shown on FIG. 1, the support 30 has an external face 30A and an internal face 30B.

More precisely, the internal face 30B of the support 30 extends on the decorative layer 32.

The support 30 has at least a part being translucent, called in the following “translucent part”.

In the present description, “translucent” means a transmission rate of the light comprised between 5% and 100%.

Advantageously, said translucent part of the support 30 is transparent.

In the present description, “transparent” means a transmission rate of the light comprised between 80% and 100%.

In the present example, the whole support 30 is translucent and advantageously transparent. Thus, in this example, the translucent part of the support 30 corresponds to the whole support 30.

The translucent part has an external face and an internal face.

At least a portion 30P of the external face of the translucent part of the support 30 forms the display area 18.

In the present example, the external face of the translucent part of the support 30 is defined by the external face 30A of the support 30. In particular, in the present example, the external face of the translucent part of the support 30 corresponds to the whole external face 30A of the support 30. Thus, in the following the external face of the translucent part of the support 30 is also referred by the numeral reference 30A.

In the present example, the internal face of the translucent part of the support 30 is defined by the internal face 30B of the support 30. In particular, in the present example, the internal face of the translucent part of the support 30 corresponds to the whole internal face 30B of the support 30. Thus, in the following the internal face of the translucent part of the support 30 is also referred by the numeral reference 30B.

At least the translucent part of the support 30 and, for example, the whole support 30 is made of a translucent material capable of being rigid. For example, the translucent material is both rigid and flexible.

For example, at least the translucent part of the support 30 and, for example, the whole support 30 is arranged to impart to the cover element 14 its general shape and its mechanical characteristics, in particular its rigidity.

The material of the support 30 is distinct from the predefined material 22. In other words, the support 30 comprises a material distinct from the predefined material 22.

At least the translucent part of the support 30, and for example the whole support 30, is in glass.

As a variant, at least the translucent part of the support 30, and for example the whole support 30, is in plastic. The translucent part of the support 30 comprises for example a layer of plastic.

The layer of plastic is for example a layer of polycarbonate (PC) or a layer of poly(methyl methacrylate) (PMMA). As a variant, the layer of plastic is obtained by coextrusion of PC and PMMA. As another variant, the layer of plastic is obtained by PC injection molding.

For example, the translucent part of the support 30, and for example the whole support 30 is in the form of a sheet, for example a sheet of glass or a sheet of plastic.

The thickness of the translucent part of the support 30 is comprised between 0.01 millimeters (mm) and 3 millimeters.

As shown on FIG. 1, the external face 30A of the translucent part of the support 30 is arranged in front of at least a portion of the decorative layer 32.

The portion 30P of the external face 30A of the translucent part of the support 30 forming the display area 18 has the texture of the predefined material 22 so that the display area 18 presents the texture of the predefined material 22. Thus, the display area 18 has the touch feeling of said predefined material 22. In other words, the display area 18 imitates the touch feeling of said predefined material 22.

Said portion 30P of the external face 30A of the support 30 extending in the display area 18 is called in the following “texture imitation portion 30P”.

The texture imitation portion 30P is translucent and for example transparent.

The texture of the texture imitation portion 30P depends for example on the roughness of said portion 30P.

As a variant or in complement, the texture of the texture imitation portion 30P depends on the macroscopic shape of said portion 30P.

As shown on FIG. 1, in the present example, the texture imitation portion 30P has the roughness of the predefined material 22. Such roughness of the texture imitation portion 30P provides in this case the feeling of touching the piece of wood of FIG. 2, and in particular the feeling of touching the wood grain of the piece of wood. In other words, the texture imitation portion 30P emulates the touch feeling of the predefined material 22.

In the particular example of FIG. 1, at least the translucent part of the support 30 comprises, for example, a substrate layer 40.

The substrate layer 40 has an external face 40A and an internal face 40B, opposed to the external face 40A.

The internal face 40B of the substrate layer 40 corresponds for example to the internal face 30B of the translucent part of the support 30.

The substrate layer 40 is translucent and advantageously translucent.

The substrate layer 40 is for example made of glass and is, for example, a sheet of glass. As a variant, the substrate layer 40 is made of plastic and is, for example, a sheet of plastic. The nature of the sheet of plastic is for example analogous to the nature of the layer of plastic mentioned above.

As shown on FIG. 2, the substrate layer 40 comprises at least an etched part.

In particular, the external face 40A of the substrate layer 40 is etched so that the external face 40A of the substrate layer 40 has the roughness of the predefined material.

For example, the substrate layer 40 has been obtained by etching. In this case, the roughness of the substrate layer 40 has been obtained by etching.

In the present example described, at least the translucent part of the support 30 comprises at least a coating layer. The or each coating layer covers the external face 40A of the substrate layer 40.

The or each coating layer is translucent and advantageously translucent.

For example, the support 30 comprises at least a first coating layer and a second coating layer.

For example, the first coating layer is arranged in sandwich between the substrate layer 40 and the second coating layer.

The second coating layer delimiting for example the texture imitation portion.

At least a coating layer of the plurality of coating layers comprises an antiglare material, called in the following “antiglare coating layer”. The antiglare material of the antiglare coating layer has, for example, the following chemical formula: TiZrO₂. The antiglare coating layer is translucent and for example transparent.

At least one another coating layer of the plurality of coating layers comprises an antireflection material, such as silicon dioxide (SiO₂), called in the following “antireflection coating layer”. The antireflection coating is translucent and for example transparent.

Those coating layers enable to obtain a display area 18 having good optical properties, namely a decreased reflectance and an increase transmittance of the substrate layer 40.

For example, the translucent part of the support 30 comprises an alternation of antireflection coating layers and of an antiglare coating layers.

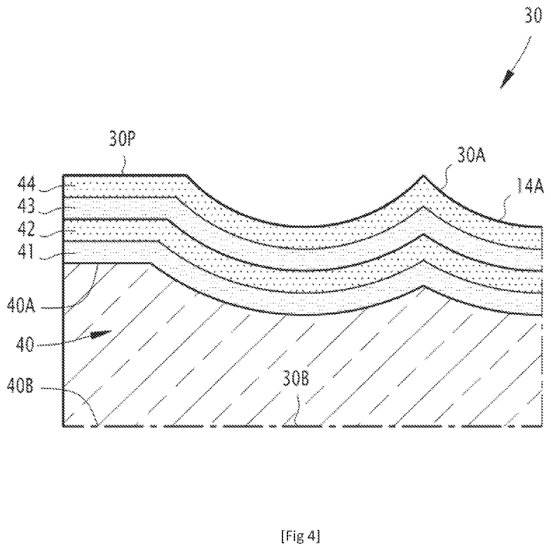

In the present embodiment and as shown on FIG. 4, the translucent part of the support 30 comprises a plurality of coatings layers, for example two antireflection coating layers and two antiglare coating layers.

In particular, as shown on FIG. 4, the translucent part of the support 30 comprises from the interior to the exterior of the cover element 14, a first coating layer 41, a second coating layer 42, a third coating layer 43 and a fourth coating layer 44. The first and third coating layers 41, 43 are antireflection coating layers and the second and fourth coating layers 42, 44 are antiglare coating layers.

In the present example, the fourth coating layer 44 the most exterior delimits the texture imitation portion 30P so that the display area 18 has the texture of the predefined material 22.

The assembly of the four coating layers 41, 42, 43, 44 fits the shape of the external face 40A of the substrate layer 40 so that the texture imitation portion 30P delimited by the fourth coating 44 has the texture of the predefined material 22, in this example the texture of wood.

The texture of the texture imitation portion 30P depends for example on the roughness and/or the macroscopic shape of the fourth layer 44.

For example, the texture of the texture imitation portion 30P also depends on at least one other parameters chosen in the list of parameters: the roughness of the first coating 41, the roughness of the second coating 42, the roughness of the third coating 43, the roughness of the substrate layer 40.

As a variant or in complement, the texture of the texture imitation portion 30P depends on the macroscopic shape of the substrate layer 40, the macroscopic shape of the first coating 41, the macroscopic shape of the second coating 42, the macroscopic shape of the third coating and/or the macroscopic shape of the fourth coating 44.

The texture imitation portion 30P matches a visual appearance imitation portion 32P of the decorative layer 32, defined in more details below, so that the texture of the texture imitation portion 30P corresponds to the texture of the predefined material 22 visually represented by the visual appearance imitation portion 32P of the decorative layer 32.

As a variant, the translucent part of the support 30 is not etched.

As a variant, the translucent part of the support 30 does comprise any coating layer. In this case, the etched part of the substrate layer 40 defines at least in part the texture imitation portion 30P.

As shown on FIG. 1, the decorative layer 32 extends at least in part in front of the display area 18.

The decorative layer 32 extends at least on the internal face 30B of the translucent part of the support 30.

For example, the decorative layer 32 extends directly (i.e. without intermediate layer) on the internal face 30B of the translucent part of the support 30.

The decorative layer 32 has an external face 32A and an internal face 32B.

At least a portion 32P of the decorative layer 32 has the visual appearance of the predefined material 22. In the following, said portion is called “visual appearance imitation portion 32P”.

The visual appearance imitation portion 32P is configured to emulate the visual appearance of the predefined material 22.

The visual appearance imitation portion 32P extends at least in front of the display area 18 so that the display area 18 presents the visual appearance of the predefined material 22.

The visual appearance imitation portion 32P of the decorative layer 32 extends at least in front of the display surface 12S of the display element 12.

The visual appearance imitation portion 32P extends at least in front of the texture imitation portion 30P.

The visual appearance imitation portion 32P of the decorative layer 32 corresponds in the present example to the part of the decorative layer 32 extending at least in front of the display area 18.

At least the visual appearance imitation portion 32P is translucent.

For example, the visual appearance imitation portion 32P presents a light transmission rate superior or equal to 30% and inferior or equal to 40%.

For example, the whole decorative layer 32 is translucent.

The visual appearance imitation portion 32P of the decorative layer 32 presents a transmission haze rate superior or equal to 10% and inferior or equal to 50%.

The transmission haze rate is for example measured according to the measurement described in the standard ASTM D1003, Procedure B—using a Spectrophotometer.

The visual appearance imitation portion 32P of the decorative layer 32 is, for example, a film. For example, the whole decorative layer 32 is a film.

The visual appearance imitation portion 32P of the decorative layer 32 has, for example, a thickness superior or equal to 180 micrometers and inferior or equal to 500 micrometers. The thickness of the visual appearance imitation portion 32P is defined by the distance separating the part of the external face 32A and the part of the internal face 32B of the decorative layer 32 extending in front of the display area 18.

The visual appearance imitation portion 32P of the decorative layer 32 comprises a decorative pattern 35 having the visual appearance of the predefined material 22.

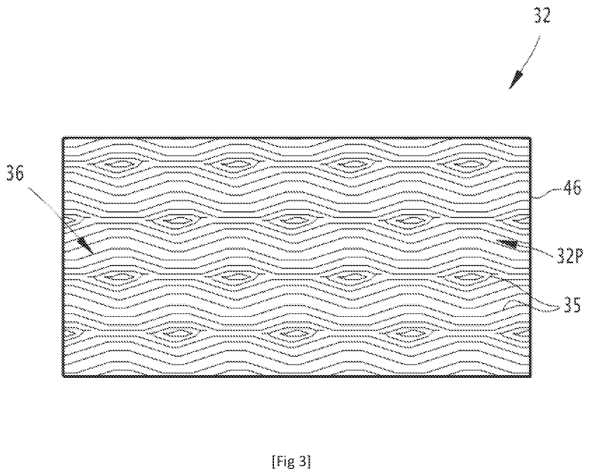

An example of a front view of the visual appearance imitation portion 32P of the decorative layer 32 is shown on FIG. 3. In this example, the decorative pattern 35 of the visual appearance imitation portion 32P comprises at least some lines and/or some knots of the pattern 24 of the surface of the predefined material 22 shown on FIG. 2.

For example, the decorative pattern 35 is an image or a filtered image of the predefined material 22.

The material of the decorative layer 32 is distinct from the predefined material 22.

According to a particular example and as shown on FIG. 1, the visual appearance imitation portion 32P comprises a base layer 46 and a decorative coating 36 extending on the base layer 46.

The base layer 46 has an external face and an internal face opposed to the external face. The internal face of the base layer 46 corresponds for example to the internal face 32B of the decorative layer 32 and to the internal surface 14B of the cover element 14.

The base layer 46 is for example in acrylonitrile butadiene styrene (ABS).

The decorative coating 36 extends on the external face of the base layer 46.

In this case, the decorative coating 36 defines an external face 32A of the decorative layer 32.

Such decorative coating 36 defines the decorative pattern 35 of the visual appearance imitation portion 32P.

For example, the decorative coating 36 is printed on the base layer 46 or obtained by vaporization on the base layer 46.

The decorative coating 36 extends on the internal face 30B of the translucent part of the support 30.

As shown on FIG. 1, the visual appearance imitation portion 32P is arranged in front of the texture imitation portion 30P.

The visual appearance imitation portion 32P is configured to hide the display element 12 in the resting configuration of the display element 12 (FIG. 5) so that the visual appearance imitation portion 32P of the decorative layer 32 is displayed in the display area 18 and the display area 18 presents the visual appearance of the predefined material 22.

Thus, the texture imitation portion 30P and the visual appearance imitation portion 32P reproduces both the visual appearance and the texture of the predefined material 22.

According to a particular example, the display assembly 10 comprises a capacitive film (not shown on the Figures) so that a user can interact with the display element 12 by contact with the display area 18.

The optical bonding layer 16 extends between the decorative layer 32 and the display surface 12S of the display element 12.

The optical bonding layer 16 ensures good transmission of light between the display element 12 and the cover element 14.

The optical bonding layer 16 comprises an optical transmission material, such as an optical glue. For example, such optical bonding layer 16 also ensures fixing between the display element 12 and the cover element 14.

The different visual configurations of the display assembly 10 are shown on FIGS. 5 and 6, depending on the configuration of the display element 12.

As shown on FIG. 5, in the resting configuration of the display element 12, the visual appearance imitation portion 32P is displayed in the display area 18 so that the display element 12 is substantially invisible to a naked eye in the display area 18. In the resting configuration, the display area 18 thus presents the visual appearance of the predefined material 22. In other words, the visual appearance imitation portion 32P can be seen by transparency by the naked eye from the external surface 14A of the cover element 14. The elements of FIG. 5 shown by transparency through the display area 18 are referenced by dotted arrows and/or doted lines.

Thus, in the resting configuration both the visual appearance imitation portion 32P and the texture imitation portion 30P enable to reproduce the visual appearance and the texture of the predefined material 22.

As shown on FIG. 6, in the illumination configuration of the display element 12, the image 20 generated by the display element 12 is displayed in the display area 18 and the visual appearance imitation portion 32P of the decorative layer 32 is substantially invisible to a naked eye in the display area 18. In the case of FIG. 6, the image 20 displayed in the display area 18 comprises pictograms corresponding to a particular functionality of the vehicle. The elements of FIG. 6 shown by transparency through the display area 18 are referenced by a dotted arrows and/or dotted lines.

Operation of the display assembly 10 is described in the following.

Initially, the display element 12 is in the resting configuration (FIG. 5). As shown on FIG. 5, the display element 12 is not visible in the resting configuration and is hidden by the visual appearance imitation portion 32P. Thus, in the resting configuration, the visual appearance imitation portion 32P of the decorative layer 32 is displayed in the display area 18. In other words, the visual appearance imitation portion 32P is visible for a naked eye in the display area 18. Thus, in this configuration of the display element 12, the display assembly 10 displays the visual appearance of the predefined material 22.

Then, when the display element 12 passes from the resting configuration (FIG. 5) to the illumination configuration (FIG. 6), the display element 12 generates the image 20 and illuminates the display area 18. In the illumination configuration, the image 20 generated by the display element 12 is displayed in the display area 18. In other words, the visual appearance imitation portion 32P of the decorative layer 32 is substantially invisible to a naked eye in the display area 18. Thus, in this configuration of the display element 12, the display assembly 10 displays a content distinct from the visual appearance of the predefined material 22.

The cover element 14 is less expensive than known cover elements while presenting a favorable aspect.

In particular, when the display element 12 is in the resting configuration, the visual appearance imitation portion 32P is displayed in the display area 18 so that the cover element 14 mimics the visual appearance and the touch feeling of the predefined material 22.

Additionally, since the layers of the cover element 14 are translucent in the display area 18, good optical properties for the cover element 14 are obtained so that when an image 20 is generated by the display element 12 in the illumination configuration, the generated image 20 displayed in the display area 18 has an optimal quality. Thus, an image 20 generated by the display element 12 can be seen in an optimal way in the display area 18 of the cover element 14 by passengers of the vehicle.

A method for producing the display assembly 10 is described in the following.

The method for producing the display assembly 10 comprising manufacturing the cover element 14 and assembling the cover element 14 to the display element 12.

The method for manufacturing the cover element 14 is described in the following.

According to an example, the method for manufacturing the cover element 14 comprises the following steps:
realizing the support 30 comprising the texture imitation portion 30 forming the display area 18,
providing the decorative layer 32 having the visual appearance imitation portion 32P, and
assembling the provided decorative layer 32 to the internal face 30B of the translucent part of the realized support 30, said portion 32P of the decorative layer 32 having the visual appearance of the predefined material extending at least in front of the display area 18.

According to an example, the step of realizing the support 30 having the texture imitation portion 30P comprises a sub-step of etching the substrate layer 40 of the translucent part of the support 30 and/or a sub-step of coating at least a coating layer 41, 42, 43, 44 on the substrate layer 40 of the translucent part support 30, for forming the texture imitation portion 30P.

For example, during the sub-step of etching, the external face 40A of the substrate layer 40 is etched so that it has the roughness of the surface of the predefined material 22.

For example, during the sub-step of coating, the external face 40A of the substrate layer 40 is coated with the first, second, third and fourth coating layers 41, 42, 43, 44.

The coating layers 41, 42, 43, 44 are applied coating by coating using, for example, metalorganic chemical vapour deposition (also known by “MOCVD”).

According to a particular example of the method of manufacturing the cover element 14, the step of realizing the support 30 depends on the values of the pixels of an acquired image of the predefined material 22 or on the values of the pixels of a filtered acquired image of the predefined material 22.

In particular, for example, the step of realizing the texture imitation portion 30P of the support 30 depends on the values of the pixels of said acquired image of the predefined material 22 or on the values of the pixels of said filtered acquired image of the predefined material 22.

In this case, the sub-step of etching and/or the sub-step of coating of the step of realizing the support 30 depends on the values of the pixels of said acquired image of the predefined material 22 or on the values of the pixels of the filtered acquired image image of the predefined material 22.

In this case, the method for manufacturing the cover element 14 further comprises, for example, the steps of:
acquiring an image of the predefined material 22,
optionally creating a grey scale image of the acquired image with 256 level resolution,
optionally filtering the grey scaled image created, the filtering comprising filtering the pixels of the grey scale image which have a value lower than a predetermined value, the predetermined value is for example 40, and
defining etching and/or coating parameters of the support 30 in function of the pixels of the acquired image or in function of the pixels of said filtered image.

The sub-step of etching and/or the sub-step of coating depend on said defined parameters.

For example, command laws of tools implementing etching and coating depends on the said defined parameters.

According to a particular example of the method, the method further comprises a step of realizing the decorative layer 32.

The step of realizing the decorative layer 32 is carried out before the step of providing the decorative layer 32.

For example, the step of realizing the decorative layer 32 comprises a step of realizing the visual appearance imitation portion 32P of the decorative layer 32. The step of realizing the visual appearance imitation portion 32P comprises a sub-step of providing the base layer 46 and a sub-step of coating the base layer 46 with the decorative coating 36 for forming the visual appearance imitation portion 32P.

For example, the sub-step of coating comprises printing the base layer 46 with the decorative coating 36 for forming the visual appearance imitation portion 32P.

According to a particular example of the method for manufacturing the cover element 14, the step of realizing the visual appearance imitation portion 32P of the decorative layer 32 depends on the values of the pixels of said acquired image of the predefined material 22 or on the pixels of said filtered acquired image of the predefined material 22. Thus, in this example, the decorative pattern 35 of said visual appearance imitation portion 32P of the decorative layer 32 reproduces said acquired image or said filtered acquired image of the predefined material 22.

In particular, in this example, the sub-step of coating the decorative coating 36 depends on the values of the pixels of said acquired image of the predefined material 22 or on the values of the pixels of said filtered acquired image. In particular, the intensity of the decorative coating 36 depends on said pixels.

For example, the provided decorative layer 32 and the obtained support 30 are assembled by lamination.

In particular, the decorative layer 32 is laminated on the internal face 30B of the support 30.

Then, the manufactured cover element 14 is assembled to the display element 12 using the optical bonding layer 16.

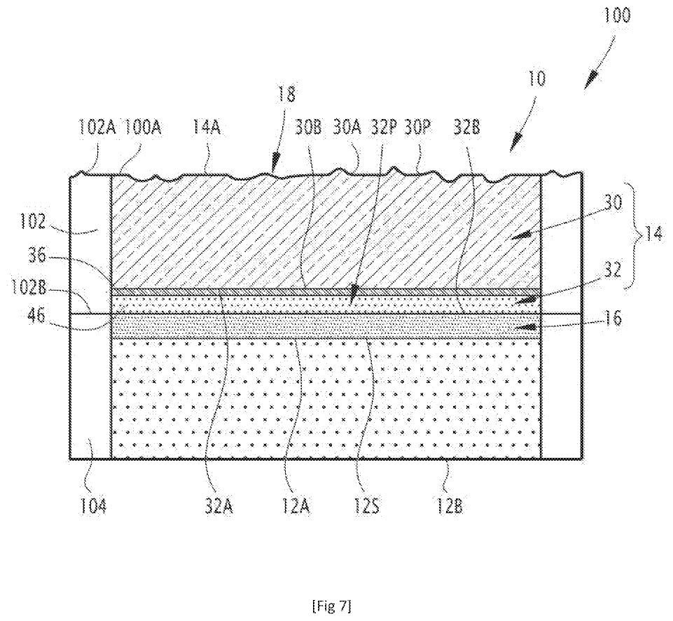

According to a particular example, the display assembly 10 is part of a trim element 100 shown on FIG. 7.

The trim element 100 is for example a trim element 100 for a vehicle. For example, the trim element 100 is a part of a dashboard, a part of a center console, a part of a seat, a part of a door panel or the like.

The trim element 100 has an external surface 100A. The external surface 100A is visible from the interior of the vehicle.

The trim element 100 comprises the display assembly 10. Additionally, the trim element 100 comprises an appearance layer 102. For example, the trim element 100 also comprises a support layer 104.

According an example, the appearance layer 102 is a decorative layer.

The appearance layer 102 has an external face 102A and an internal face 102B.

As shown on FIG. 7, at least a portion of the external face 102A of the appearance layer 102 extends around the display area 18 of the cover element 14.

According to an example, said part of the external face 102A of the appearance layer 102 is arranged edge to edge to the texture imitation portion 30P.

The external face 102A of the appearance layer 102 and the texture imitation portion 30P form the external surface 100A of the trim element 100.

The external face 102A of the appearance layer 102 has at least the same visual appearance as the visual appearance imitation portion 32P.

Advantageously, the external face 102A of the appearance layer 102 has the same texture as the texture imitation portion 30P.

According to an example, the appearance layer 102 is made in the predefined material 22.

The internal face 10B of the appearance layer 102 extends on the support layer 104.

Another embodiment of the display assembly is described in the following (not represented on the Figures). The display assembly of this embodiment is described only by differences from the display assembly of FIGS. 1 to 7. The display assembly of this embodiment differs from the display assembly of FIGS. 1 to 7 only by the decorative layer 32.

In this embodiment, the internal face 30B of the translucent part of the support 30 is coated with the decorative layer 32 having the visual appearance imitation portion.

In this case, the visual appearance imitation portion 32P of the decorative layer 32 comprises the decorative coating 36 but does not comprise the base layer 46 as in the embodiments of FIGS. 1 to 7.

The method for manufacturing the display assembly of this embodiment is described only by differences from the method for manufacturing the display assembly 10 of FIGS. 1 to 7.

The method for manufacturing the display assembly of this embodiment differs from the method for manufacturing the display assembly 10 of FIGS. 1 to 7 in that it comprises a step of coating the decorative layer 32 on the internal face 30B of the translucent part of the realized support 30 to form at least said visual appearance imitation portion 32P, said visual appearance imitation portion 32P of the coated decorative layer 32 extending at least in front of the display area 18.

For example, during the step of coating, the internal face 30B of the translucent part of the support 30 is coated with the decorative coating 36.

For example, in this case, the step of coating comprises printing or spraying the translucent part of the support 30 with the decorative coating 36 for obtaining the visual appearance imitation portion 32P of the decorative layer 32. For example, the visual appearance imitation portion 32P reproduces the acquired image of the predefined material 22 or the filtered acquired image of the predefined material 22.

The method for manufacturing the display assembly of this embodiment thus differs from the method for manufacturing the display assembly 10 of FIGS. 1 to 7 in that the steps of realizing the decorative layer 32, producing the decorative layer 32 and assembling the decorative layer 32 to the support 30 are implemented simultaneously and comprise said step of coating the decorative layer 32.

1. Cover element having a display area designed to extend in front of a display element configured to generate a displayed content, the display area forming at least a part of an external surface of the cover element, the display area being configured to present a visual appearance of a predefined material and the display area having a texture of the predefined material, the cover element comprising:
a support comprising at least a part being translucent, said translucent part of the support having an external face and an internal face opposed to the external face, at least a portion of the external face of the translucent part of the support forming the display area, said portion of the external face of the translucent part of the support having the texture of the predefined material, the support comprising a material distinct from said predefined material, and
a decorative layer extending at least on the internal face of the translucent part of the support, at least a portion of the decorative layer having the visual appearance of the predefined material, said portion of the decorative layer extending at least in front of the display area.

2. Cover element according to claim 1, wherein said portion of the decorative layer comprises a decorative pattern having the visual appearance of the predefined material.

3. Cover element according to claim 1, wherein at least said portion of the decorative layer is translucent and advantageously presents a light transmission rate superior or equal to 30% and inferior or equal to 40%.

4. Cover element according to claim 1, wherein at least said portion of the decorative layer presents a transmission haze rate superior or equal to 10% and inferior or equal to 50%.

5. Cover element according to claim 1, wherein said portion of the decorative layer has a thickness superior or equal to 180 micrometers and inferior or equal to 500 micrometers.

6. Cover element according to claim 1, wherein at least the translucent part of the support comprises a substrate layer, at least an etched part of the substrate layer defining at least in part said portion of the external face of the translucent part of the support and/or at least the translucent part of the support comprising at least a coating layer extending on the substrate layer and delimiting at least in part said portion of the external face of the translucent part of the support.

7. Cover element according to claim 6, wherein at least the translucent part of the support comprises at least a coating layer extending on the substrate layer, the coating layer delimiting at least in part said portion of the external face of the translucent part of the support, the coating layer comprising an antiglare material, the antiglare material having preferably the following chemical formula: TiZrO₂.

8. Cover element according to claim 6, wherein at least the translucent part of the support comprises at least a coating layer extending on the substrate layer, the coating layer delimiting at least in part said portion of the external face of the translucent part of the support, the coating layer comprising an antireflection material, the antireflection material being preferably silicon dioxide.

9. Display assembly comprising:
the cover element according to claim 1,
a display element configured to generate a displayed content,
the display area of the cover element extending in front of the display element,
said display assembly being configured to display in the display area the visual appearance of the predefined material when said display element is turned off and said display assembly being configured to display in the display area the displayed content when said display element is turned on, said displayed content being different from the visual appearance of the predefined material.

10. Method for manufacturing a cover element having a display area designed to extend in front of a display element configured to generate a displayed content, the display area forming at least a part of an external surface of the cover element, the display area being configured to present the visual appearance of a predefined material and the display area having the texture of the predefined material, the method comprising the following steps:
realizing a support comprising at least a part being translucent, said translucent part of the support having an external face and an internal face opposed to the external face, at least a portion of the external face of the translucent part of the support forming the display area, said portion of the external face of the translucent part of the support having the texture of the predefined material, the support comprising a material distinct from said predefined material,
the step of realizing the support comprising a sub-step of etching at least a part of a substrate layer of the translucent part of the support and/or a sub-step of coating at least a coating layer on a substrate layer of the translucent part of the support to form said portion of the external face of the translucent part of the support having the texture of the predefined material,
providing a decorative layer having at least a portion having the visual appearance of the predefined material, and
assembling the provided decorative layer to the internal face of the translucent part of the realized support, said portion of the decorative layer having the visual appearance of the predefined material extending at least in front of the display area.

11. Method for manufacturing a cover element having a display area designed to extend in front of a display element configured to generate a displayed content, the display area forming at least a part of an external surface of the cover element, the display area being configured to present a visual appearance of a predefined material and the display area having the texture of the predefined material, the method comprising the following steps:
realizing a support comprising at least a part being translucent, said translucent part of the support having an external face and an internal face opposed to the external face, at least a portion of the external face of the translucent part of the support forming the display area, said portion of the external face of the translucent part of the support having the texture of the predefined material, the support comprising a material distinct from said predefined material,
the step of realizing the support comprising a sub-step of etching at least a part of a substrate layer of the translucent part of the support and/or a sub-step of coating at least a coating layer on a substrate layer of the translucent part of the support to form said portion of the external face of the translucent part of the support having the texture of the predefined material,
coating a decorative layer on the internal face of the translucent part of the realized support to have at least a portion having the visual appearance of said predefined material, said portion of the coated decorative layer extending at least in front of the display area.

12. Trim element for a vehicle comprising a display assembly according to claim 9, the trim element comprising advantageously an appearance layer having an external face, at least a part of the external face of the appearance layer extending at least partially around the display area of the cover element of the display assembly, said part of the external face of the appearance layer having a visual appearance similar to the visual appearance of the portion of the decorative layer of the cover element having the visual appearance of the predefined material.
